(19) United States
(12) Patent Application Publication
(10) Pub. No.: US 2002/0190028 A1
(43) Pub. Date: Dec. 19, 2002

(54) Method of improving uniformity of etching of a film on an article

(75) Inventors: Kamalesh K. Srivastava, Wappingers Falls, NY (US); Mary C. Cullinan-Scholl, Hopewell Junction, NY (US); Lisa A. Fanti, Hopewell Junction, NY (US); Jonathan H. Griffith, LaGrangeville, NY (US); Randolph F. Knarr, Poughkeepsie, NY (US)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 09/870,534

(22) Filed: May 31, 2001

(51) Int. Cl. B44C 1/22; C23F 1/00

(52) U.S. Cl. 216/90

(57) ABSTRACT

A method of improving the uniformity of etching of a film on an article, the method including the steps of immersing the article containing the film into a tank of etchant, rotating the article while in the etchant for a desired amount of time so as to cause improved uniformity of etching of the film compared to etching without rotating the article, and removing the article from the tank of etchant. In a preferred embodiment of the invention, the article is a semiconductor wafer.

### BACKGROUND OF THE INVENTION

The present invention relates to the etching of metallic and nonmetallic films on articles and, more particularly, relates to the etching of metallic and nonmetallic films on semiconductor wafers.

C4 is an advanced microelectronic chip packaging and connection technology. “C4” stands for Controlled Collapse Chip Connection. C4 is also known as “solder bump”, “solder balls” and “flip chip” and these terms may also be used in conjunction such as “C4 solder bump”.

The basic idea of C4 is to connect chips (semiconductor devices), chip packages, or such other units by means of solder bumps between two surfaces of the units. These tiny bumps of electrically conductive solder bridge the gaps between respective pairs of metal pads on the units being connected. Each pad has a corresponding pad on the other unit's surface; the pad arrangements are mirror images. As the units are pressed together and heated the solder bumps on the pads of the first unit are contacted with corresponding conductive pads (having no bumps) on the second unit and reflowed, partially collapsing the solder bumps and making connections between respective pads.

In C4 the solder bumps are formed directly on the metal pads of the one unit. The pads are electrically isolated from other components by the insulating substrate that surrounds each pad. The substrate might be silicon (Si) or some other material. The bottom of the pad is electrically connected into the chip circuit.

A major application of C4 is in joining chips to a carrier or package. Chips usually are made in rectangular arrays on a mono-crystalline slab of silicon, called a “wafer”. Many chips are formed on each wafer, and then the wafer is broken up into individual chips and the chips are “packaged” in units large enough to be handled. The C4 bumps are placed on the chips while they are still joined in a wafer.

The wafers are made as large as possible so as to reduce the number of wafers that must be processed to make a certain number of chips. For the same reason (among others) the chips are made as small as possible. Thus, the best C4 fabrication system is one that can make thousands of very small, closely-spaced solder bumps each precisely placed over a large area.

The C4 solder bumps may be formed by the deposition of solder onto a continuous stack of metal films across the wafer to be bumped. One example of such a stack is titanium tungsten/chromium/phased chromium copper/copper (TiW/Cr/Cr—Cu/Cu). The solder may be evaporated or plated as is known in the art. The method of deposition of the solder is not important to the present invention. The stack of metal films remains under the solder bump in the final structure and forms the basis for the so-called ball limiting metallurgy (BLM). The stack of metal films is removed in between the solder bumps to electrically isolate them by suitable wet and/or electrolytic etching processes.

The challenge in the etching processes is to effectively remove or etch the metal films without otherwise harming the C4 solder bumps. A fuller explanation of the formation of the C4 solder bumps and the etching of the stack of metal films can be found in Datta et al. U.S. Pat. No. 5,462,638, the disclosure of which is incorporated by reference herein.

It has been found that wet etching of the stack of metal films is complicated by the presence of C4 solder bumps. The present inventors have further found that the stack of metal films wet etches slower at the kerf area of the semiconductor wafer where there are usually no C4 solder structures.

It would therefore be desirable to be able to wet etch a semiconductor wafer with improved uniformity of etching.

Takeshi Japanese Published Patent Application JP9115977A2, the disclosure of which is incorporated by reference herein, discloses a method for determining crystalline defect density in a semiconductor wafer by etching the semiconductor wafer, counting the number of defects, rotating the semiconductor wafer less than one revolution, etching some more and then removing the semiconductor wafer from the etchant. This reference has no teaching with respect to improving the wet etching uniformity of a metallic or nonmetallic film on a semiconductor wafer.

It is a purpose of the present invention to have a method to wet etch films on semiconductor wafers without adversely affecting the C4 solder bumps.

It is a further purpose of the present invention to have a method to wet etch films on semiconductor wafers more uniformly than heretofore had been possible without adversely affecting the C4 solder bumps.

These and other purposes of the present invention will become more apparent from the following description considered in conjunction with the accompanying drawings.

### BRIEF SUMMARY OF THE INVENTION

The purposes of the invention have been achieved by providing, according to a first aspect of the invention, a method of improving the uniformity of etching of a film on an article, the method comprising the steps of:

immersing the article containing the film into a tank of etchant;

rotating the article while in the etchant for a predetermined amount of time so as to cause improved uniformity of etching of the film compared to etching without rotating the article; and

removing the article from the tank of etchant.

According to a second aspect of the invention, there is provided a method of improving the uniformity of etching of a film on a semiconductor wafer, the method comprising the steps of:

immersing the semiconductor wafer containing the film into a tank of etchant;

rotating the semiconductor wafer while in the etchant for a predetermined amount of time; and

removing the semiconductor wafer from the tank of etchant.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a schematical representation of a portion of a semiconductor wafer that is to be etched.

FIG. 2 is a view from the front of an apparatus for practicing the method of the present invention.

FIG. 3 is a view from the back of an apparatus for practicing the method of the present invention.

FIG. 4 is a view from the side of an apparatus for practicing the method of the present invention.

### DETAILED DESCRIPTION OF THE INVENTION

While the present invention has general applicability to the improvement in uniform etching of articles having metallic and nonmetallic films, the preferred embodiment of the present invention will be described with respect to the improvement in uniform etching of a silicon semiconductor wafer having a metallic film and C4 solder bumps. The preferred embodiment is not meant to be limiting with respect to the scope of the present invention.

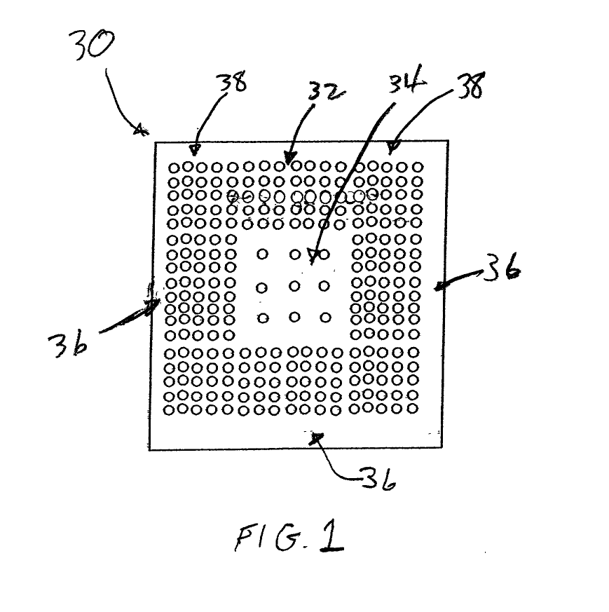

As noted above, the presence of the C4 solder bumps complicates the wet etching of the metallic film. While not wishing to be held to a particular theory, it is believed that the presence of bubbles among the C4 solder structures, as a result of the etchant reaction with the metallic film, causes increased etching among the C4 solder structures. For example, referring to FIG. 1, there is shown a layout of one semiconductor device 30 on a semiconductor wafer. The semiconductor device 30 has areas 32 of dense C4 solder bumps, areas 34 of sparse C4 solder bumps and kerf areas 36 where there are no solder bumps. Consequently, the etching varies from the greatest among the areas 32 of dense C4 solder bumps to the lowest in the kerf areas 36. Moreover, the effect of the bubbles is cumulative so the more rows of dense C4 solder bumps there are, the more will be the etching and this effect will be the greatest at the top of the semiconductor device 30 due to the vertical rise of the bubbles. As shown in FIG. 1, the greatest amount of etching will occur at 38 which is just above the dense C4 solder bumps on the left and the right of the semiconductor device 30.

For all these reasons, uniformly wet etching a semiconductor wafer, particularly one with C4 solder bumps is problematical at best.

Accordingly, the present inventors have proposed a method of improving the uniformity of wet etching of a film on an article, particularly a semiconductor wafer. According to the method of the present invention, the article containing the film is immersed into a tank of etchant and then rotated while in the etchant for a predetermined amount of time. The predetermined amount of time should be sufficient to attain the desired amount of removal of the film. That is, the film may be partially removed, i.e., thinned, or entirely removed. In one preferred embodiment, the film is entirely etched away. By rotating the article, improved uniformity of wet etching of the film results as compared to wet etching without rotating the article. The article is then removed from the etchant tank.

The film on the article could be a metallic film or a nonmetallic film. The process according to the present invention should work equally well for both applications.

The step of rotating the article can be done on a continuous basis or sequentially. When continuously rotating the article, the article is preferably rotated at a speed of 1 to 5 revolutions per minute although the rotational speed could be increased substantially in a given case, for example, to 10 revolutions per minute, so long as the higher speed does not disrupt the etchant laminar flow.

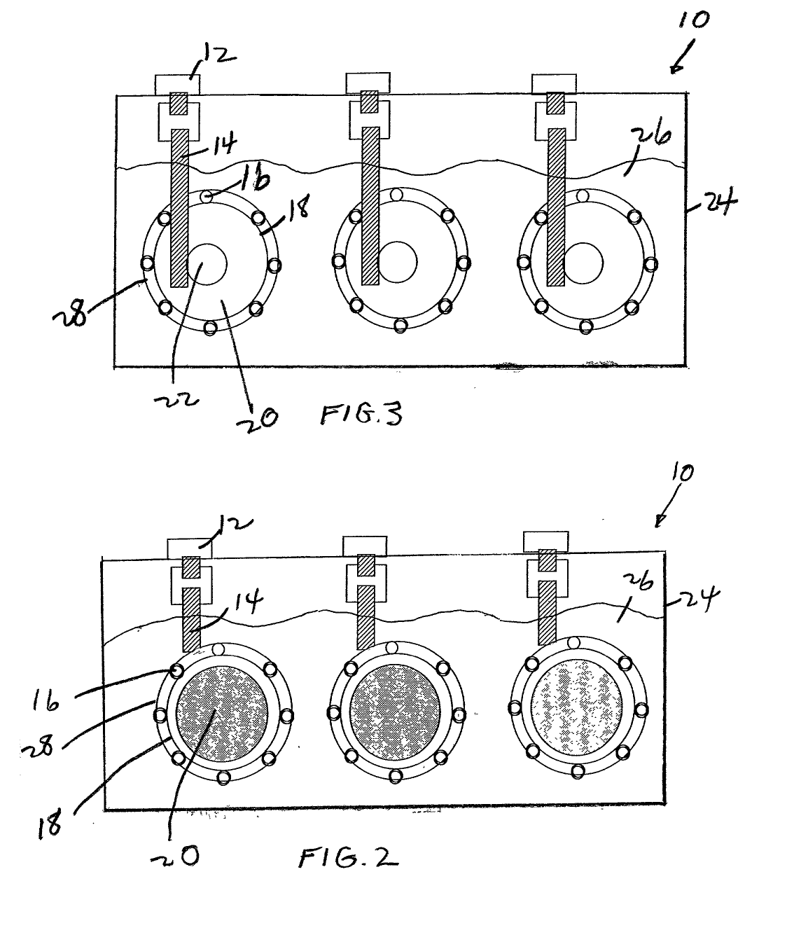

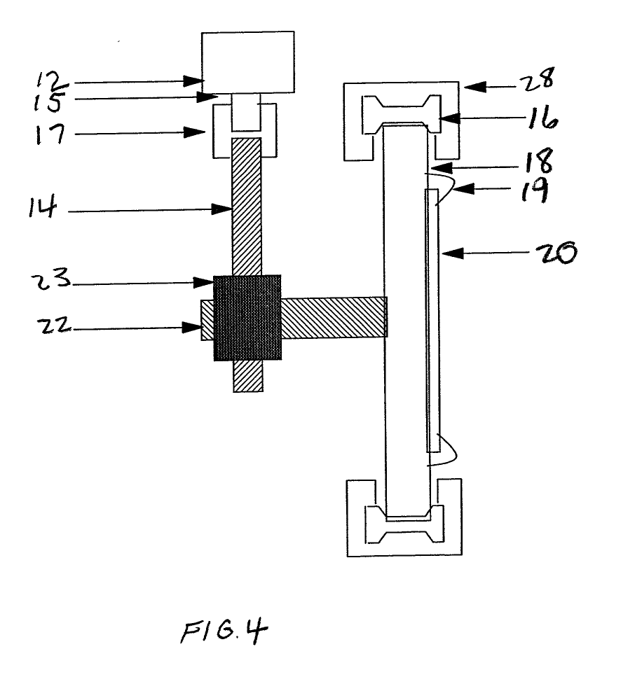

When rotating the article sequentially, this can be accomplished, for example, by rotating the article a predetermined amount but less than a complete rotation, wet etching the article for a predetermined amount of time, rotating the article a predetermined amount but less than a complete rotation and wet etching again, and so until the article is etched the desired amount. As one example, the article may be rotated in 90° increments. Smaller or larger rotation angles may be desirable to optimize the process. A sample apparatus for etching and rotating the articles is shown in FIGS. 2 to 4. FIG. 2 is the front of the apparatus, FIG. 3 shows the apparatus from the back side and FIG. 4 shows the apparatus from the side.

Referring to FIGS. 2 to 4 simultaneously, apparatus 10 for practicing the present invention includes a tank 24 having etchant 26 into which the articles will be immersed. (Tank 24 and etchant 26 are not shown in FIG. 4.) There are a plurality of stations for etching and rotating the articles. Each station consists of a motor 12 (electric, pneumatic or hydraulic) rotating a shaft 15 coupled by coupling 17 to vertical gear 14 which in turn rotates horizontal gear 22 through gear box 23. Horizontal gear 22 is connected to rotating chuck 18 which rotates on ball bearings 16 in stationary housing 28. Clips 19 (shown in FIG. 4) are present to hold the article 20 on rotating chuck 18. Accordingly, upon activation of motor 12, the article 20, in this case a semiconductor wafer, is caused to rotate, continuously or sequentially, as desired, for a predetermined amount of time to improve the uniformity of the etching a film on article/semiconductor wafer 20.

The advantages of the invention will become more apparent after referring to the following Examples.

### EXAMPLES

A series of semiconductor wafers were prepared having a blanket metallic film of titanium/tungsten (TiW). On top of the blanket TiW film is a pattern of C4 solder bumps similar to that shown in FIG. 1. The wafers were immersed in an etchant consisting of hydrogen peroxide (150-250 grams/liter), potassium sulfate (150-200 grams/liter) and dipotassium diamine tetra acetate (7-11 grams/liter) for 200 seconds. The pH of the solution was kept in the range of 3 to 4. Wafer A was not rotated, wafer B was continuously rotated at a speed of 1 rpm while wafer C was sequentially rotated at increments of 90°. The uniformity of the TiW metallic film was measured in terms of sheet resistivity before and after etching. The uniformity is expressed in terms of percent standard deviation of the sheet resistivity and the circular symmetry of the TiW film in terms of sheet resistivity for pre and post etch conditions, respectively. As deposited TiW film thickness contours are circular in shape. This means film thickness variations are only in radial direction and not in angular direction. In terms of radial coordinates (r,θ), the thickness varies only with variation in r and does not vary with θ. Uniform etching preserves the circular symmetry of thickness contours. Any nonuniformity in etching tends to distort the circular symmetry of the film thickness contour.

The results are specified in Table I.

A second series of semiconductor wafers were prepared having a fully patterned wiring structure and C4 solder bumps. Patterned wafers having C4 solder bumps do not allow the use of four point probes to measure sheet resistance which, as noted previously, is an indicator of film thickness. Patterned wafers, however, have so-called fuse alignment marks (not shown) in the kerf 36 of each semiconductor device 30 which are used to align a laser that is used to blow fuses in the semiconductor device. The fuse alignment marks are covered by the TiW film during the formation of the C4 solder bumps and must be completely removed when the film is etched so that they can be read by a laser. If the fuse alignment marks for a particular semiconductor device are covered after etching of the TiW film, the fuse blow alignment success rate for that semiconductor device is said to be zero %. Conversely, the fuse blow alignment success rate is 100% when the fuse alignment marks can be read by the laser. For the entire patterned wafer, the cumulative fuse blow alignment success rate is somewhere between zero and 100%, with 100% being ideal.

In the case of the patterned wafers in this example, the fuse blow alignment success rate was measured at zero percent undercut of the C4 BLM. Zero percent undercut of the C4 BLM means that during the etching of the metal stack that makes up the BLM, the metal stack was completely removed (etched) from the wafer except that it was not etched directly underneath the C4 solder balls. A higher success rate without C4 BLM undercut is a result of higher level of wet etch uniformity.

The etchant used was the same as that used in the first series of wafers. In this case, the etchant time was 320-540 seconds depending on when the TiW film was completely removed. The endpoint of the etching time may be determined by a suitable endpoint detect method, such as that disclosed in Barbee et al. U.S. Pat. No. 5,445,705, the disclosure of which is incorporated by reference herein.

The results of these experiments are tabulated in Table I.

TABLE I

| | TiW Thickness | TiW Thickness | Fuse Blow |
|---|---|---|---|
| | Uniformity (%) | Uniformity (%) | Alignment |
| | before wet | after wet | Success Rate |
| Condition | etching | etching | (%) |
| A. Blanket TiW | 2.83 | 5.77 | N/A |
| film | Radially | Radially | |
| Wet etch | symmetric | unsymmetric | |
| Without | thickness | thickness | |
| rotation | distribution | distribution | |
| B. Blanket TiW | 2.80 | 3.75 | N/A |
| film | Radially | Radially | |
| Wet etch | symmetric | symmetric | |
| Continuous | thickness | thickness | |
| rotation | distribution | distribution | |
| C. Blanket TiW | 3.07 | 4.03 | N/A |
| film | Radially | Radially | |
| Wet etch | symmetric | symmetric | |
| Sequential | thickness | thickness | |
| rotation | distribution | distribution | |
| (0°, 90°, 180°, | | | |
| 270°) | | | |
| D. Patterned | N/A | N/A | 0 |
| wafer, TiW | | | |
| film | | | 0% overetch |
| Wet etch | | | |
| Without | | | |
| rotation | | | |
| E. Patterned | N/A | N/A | 78 |
| wafer, | | | |
| TiW film | | | 0% overetch |
| Wet etch | | | |
| Sequential | | | |
| rotation | | | |
| (0°, 90°, 180°, | | | |
| 270°) | | | |

Etching uniformity improvement can be measured by subtracting the TiW thickness uniformity percents post-etch and dividing by the larger one. Comparing samples A and B, the improvement in etch uniformity is ((5.77-3.75)/5.77)*100 or about a 35% improvement in wet etch uniformity of sample B as compared to sample A. A similar analysis for samples A and C, while also adjusting for the greater TiW thickness uniformity for sample C, leads to about a 34% improvement in wet etch uniformity of sample C as compared to sample A.

With respect to samples D and E, it can be seen that the fuse blow alignment success rate increases from 0 to 78%.

Overall, it can be seen that the present invention leads to a great improvement of wet etch uniformity and an increase in the fuse blow alignment success rate. The advantages of the present invention have thus been demonstrated.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. A method of improving the uniformity of etching of a film on an article, the method comprising the steps of:
immersing the article containing the film into a tank of etchant;
rotating the article while in the etchant for a predetermined amount of time so as to cause improved uniformity of etching of the film compared to etching without rotating the article; and
removing the article from the tank of etchant.

2. The method of claim 1 wherein the step of rotating comprises sequentially rotating the article.

3. The method of claim 1 wherein the step of sequentially rotating comprises rotating the article a predetermined amount but less than a complete rotation, etching the article a predetermined amount of time, and repeating the steps of rotating and etching for a predetermined amount of time.

4. The method of claim 1 wherein the step of rotating comprises continuously rotating the article a predetermined amount of time.

5. The method of claim 1 wherein in the step of rotating, the article is rotated at a speed of 1 to 5 revolutions per minute.

6. The method of claim 1 wherein the film is a metallic film.

7. The method of claim 1 wherein the film is a nonmetallic film.

8. A method of improving the uniformity of etching of a film on a semiconductor wafer, the method comprising the steps of:
immersing the semiconductor wafer containing the film into a tank of etchant;
rotating the semiconductor wafer while in the etchant for a predetermined amount of time; and
removing the semiconductor wafer from the tank of etchant.

9. The method of claim 8 wherein the step of rotating comprises sequentially rotating the semiconductor wafer.

10. The method of claim 8 wherein the step of sequentially rotating comprises rotating the semiconductor wafer a predetermined amount but less than a complete rotation, etching the semiconductor wafer a predetermined amount of time, and repeating the steps of rotating and etching for a predetermined amount of time.

11. The method of claim 8 wherein the step of rotating comprises continuously rotating the semiconductor wafer a predetermined amount of time.

12. The method of claim 8 wherein in the step of rotating, the semiconductor wafer is rotated at a speed of 1 to 5 revolutions per minute.

13. The method of claim 8 wherein the semiconductor wafer further comprises a plurality of solder bumps on the film.

14. The method of claim 8 wherein the film is a metallic film.

15. The method of claim 8 wherein the film is a nonmetallic film.
